(19) United States
(12) Patent Application Publication
(10) Pub. No.: US 2010/0058381 A1
(43) Pub. Date: Mar. 4, 2010

(54) Methods and Apparatus for Dynamic Construction of Personalized Content

(75) Inventors: Lee Begeja, Gillette, NJ (US); David C. Gibbon, Lincroft, NJ (US); Paul van Vleck, Austin, TX (US)

Correspondence Address: AT & T LEGAL DEPARTMENT - PG, ATTN: PATENT DOCKETING , ROOM 2A- 207, ONE AT &T WAY, BEDMINSTER, NJ, 07921, US

(73) Assignee: AT&T Labs, Inc., Austin, TX (US)

(21) Appl. No.: 12/204,265

(22) Filed: Sep. 4, 2008

(51) Int. Cl. H04N 7/025

(52) U.S. Cl. 725/34

(57) ABSTRACT

Systems and techniques for delivering custom created content to users. As programming content is delivered to a user, the content selected for delivery is continuously monitored. When a point is reached in the delivered content appropriate for delivery of custom created content such as an advertisement, stored user information is examined and analyzed to identify content to which the user is likely to be receptive. Customized content is constructed based on the identification, by collecting and organizing media objects, and the constructed content is placed in the content being delivered.

### FIELD OF THE INVENTION

The present invention relates generally to improved techniques for creation and delivery of custom created content to users of information services, such as entertainment services. More particularly, the invention relates to improved systems and methods for analyzing user characteristics and activity, and using the results of the analysis to create, select, and assemble content elements suited to the user.

### BACKGROUND OF THE INVENTION

Delivery of information to users takes many forms, including entertainment, communication, and information services, information delivery services are increasing in scope and sophistication, with most types of services exhibiting an increasing ability to deliver desired content in real time. In addition, the ability to collect and analyze user information and to create content as it is being delivered has become greater and can only be expected to increase in scope and sophistication in coming years.

Relatively inexpensive resources currently exist for storing and managing huge volumes of data, so that it is now relatively easy to store and manage high quality elements of audiovisual content. Significant quantities of such content can be stored locally on user's equipment, and centralized storage serving large numbers of users can store a very large number of audiovisual elements.

Historically, delivery of information to users has been more or less imprecise. It has been difficult to tailor content to a specific user and frequently, particularly in the case of advertising, content has been delivered that is of little or no interest to a large proportion of users. Even in cases of advertisements that are of interest to users, various elements of particular advertisements may be more or less interesting or relevant to different groups of users. Nevertheless, advertisements have typically been constructed as units and delivered to categories of users who have been deemed to be receptive to the advertisements, without tailoring the construction of the advertisements to the specific interests of particular users. Numerous versions of many advertisements exist, and each version of an advertisement is typically presented at various times to unreceptive users, to users who are more receptive to different versions of the advertisement, and to users who are most receptive to the version being presented.

Similarly, content of entertainment, such as television, is adapted to a general audience and each program is typically presented as a unit. Often, advertising content is integrated in television programs and movies, as when a vendor pays to have a product, such as a soft drink, used in a movie or television scene. As in the case of more traditional advertisements, viewers may be more or less likely to be influenced by a particular product placed in a program or movie, but with traditional content delivery the same product is placed in the same content for all viewers in the hope that some portion of the viewers will be influenced by the placement of the product.

Similar concerns apply to content delivery through other mechanisms. For example, wireless communication services and broadband services deliver various forms of content upon explicit user selection or upon selection based on criteria such as user demographics or interests. Considerable information may be available as to the nature of an activity being undertaken by a user, and may be employed to select content based on the interests indicated by that activity. However, even in such cases, an item such as an advertisement, message, or other element, is typically selected and delivered as a unit, and will often include elements of lesser interest to some portion of the audience.

### SUMMARY OF THE INVENTION

Among its several aspects, the present invention recognizes the need for improved delivery of individually constructed content to users in contexts such as described above and as rapid delivery of content to consumers continues to evolve in the future. In one aspect, the invention takes advantage of the ability to gather and use information relating to user interests and to store, organize, manipulate, combine, and deliver large volumes of data in numerous different forms. A system according to an aspect of the present invention may provide television delivery services. Such a system may maintain one or more information repositories stored on one or more servers or other data processing and storage devices, and may store information relating to user interest in and receptiveness to various elements of content. An exemplary system is discussed here in the context of constructing and delivering advertising content, but the systems and techniques described herein can be extended to other forms of content as desired.

A collection of media objects, such as video clips, sound clips, pictures, text, computer generated images including static images and animations, and other desired objects, are also stored, with each media object having associated index information that can be used for retrieval and for controlling usage. Descriptive and categorization information for each media object may be stored to allow for selection of appropriate objects. Frameworks for presentation for various types of advertisements are also stored, with specific media objects being selected for presentation in a particular framework. When an advertisement is to be presented, such as at a programming break or as a product placement, an appropriate framework is selected and populated with media objects appropriate for the user interests at the time the selection is made.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a system 100 for delivering programming content according to an aspect of the present invention; and

FIG. 2 illustrates a process 200 of delivering programming content according to an aspect of the present invention.

### DETAILED DESCRIPTION

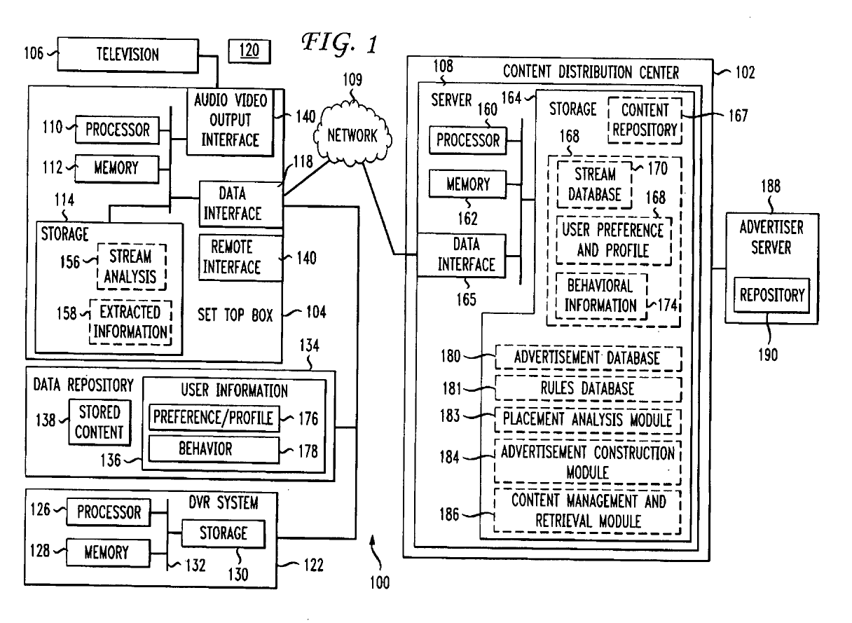

FIG. 1 illustrates a block diagram of a system 100 providing advertising selection, construction, and delivery using systems and techniques according to an aspect of the present invention. The system 100 includes a content distribution center 102 communicating with a set top box 104, which delivers content to a user television set 106. The content distribution center may suitably include a server 108, which manages programming data and transmits it over an entertainment distribution network 109 to the set top box 104 and typically to numerous additional set top boxes as well. A single server 108 is illustrated here for simplicity, but it will be recognized that data processing resources implemented by the distribution center 102 may be organized however desired.

The set top box 104 may suitably include a processor 110, memory 112, and storage 114, communicating over a bus 116. The set top box 104 also includes a data interface 118, for sending data to and receiving data from the distribution center 102. The data communicated between the set top box 104 and the distribution center 102 may suitably include audio and video streams sent by the communication center 102, commands and other information sent from the distribution center 102, and commands, requests, and data sent from the set top box 104 to the distribution center 102.

The set top box 104 implements various data processing elements to receive and analyze data, such as video and audio data, from the distribution center 102, and to communicate with the server 108 and other data processing and communication equipment.

The set top box 104 may suitably receive user inputs from a user remote control 120. The remote control 120 may allow a user to search schedules, choose programming, schedule recording of programming, and enter other information. For example, in a household with multiple users, it may be desirable to allow a user to identify himself or herself using the remote control. Such user identification would be stored and used to aid in selecting appropriate content for the user.

The set top box 104 may suitably have access to local storage, such as a digital video recording (DVR) system 122. The digital video recording system 122 suitably includes a processor 126, memory 128, and long term storage 130, communicating over a bus 132. The DVR system 122 buffers, saves, and plays back content received by the set top box 104 from the server 108.

The set top box 104 may also have access to a data repository 134. The data repository 124 may suitably include a user information repository 136 and a stored content repository 138. The stored content repository 138 may suitably store user created content and saved video content. User created content may include content such as video clips, audio clips, pictures, and other content elements that have been generated by the user and stored to the repository 138. User created content may also encompass content that has been captured by a user on other user equipment, such as a user's computer, and transferred to the stored content repository 138, even though such content may not actually have been generated by the user. Saved video content may include content that is delivered to the user from the content distribution center 102 and that the user captures or otherwise selects for storage to the stored content repository 138. Such content may be selected for use in constructing advertisements and other content tailored to the user.

The set top box 104 may include an audio video output interface 140 for communicating with the television set 106 or other suitable audio or video devices and a remote control interface 144 for communicating with the remote control 120.

The set top box 104 receives video and audio from the server 108 in the form of data, which is processed to perform channel selection. The data comprising the selected channel is presented to the user in the form of a presentation stream. The presentation stream may be routed to the DVR 122, which may store a representation of the presentation stream in the storage 130, or may pass it through while buffering it for pausing, rewinding, or storage. The DVR delivers an output stream upon an appropriate selection by the user, and this output stream may suitably be referred to as a delivery stream. The delivery stream is routed to the audio video output interface and is also processed by a stream analysis module 156, suitably implemented as software hosted in the storage 114 and transferred to memory 112 as needed for execution by the processor 110.

The stream analysis module 156 analyzes the delivery stream and extracts relevant information from the stream. Information that may be extracted includes the nature of the content that is being presented, the time that has been reached in the presentation, and user behavior with respect to the content, such as channel changes, pausing, rewinding, or fast forwarding through content. If the set top box 104 receives user identification information, the extracted information may include this user identification information. The content supplied by the server 108 may also include advertisement markers, marking starting and ending markers for advertisement blocks, with a starting marker also noting the length of the advertisement block.

Extracted information may also include various objects appearing in a presentation. Such information can be particularly useful for product placement, with an object in a scene being identified and substituted with a related object, such as a different brand of beverage or a different model of automobile.

The extracted information may be continuously used by the set top box 104 itself, and also supplied to the server 108, for use in substantially real time selection and construction of advertisements. The extracted information may also be compiled and used to inform further selection of construction of advertisements, because it may provide valuable insight into user behavior and preferences. The information extracted by the stream analysis module 156 may suitably be stored in an extracted information database 158, stored in the long term storage 114. The database 158, or selected information therefrom, may also be supplied to the server 108. The server 108 may suitably include a processor 160, memory 162, and long term storage 164, communicating over a bus 166. The server 108 includes a content repository 167 residing in the long term storage 164. The content repository 167 stores a collection of media objects to be used in advertisements. Each of these media objects may comprise a complete advertisement or a segment of an advertisement. Segments of advertisements may be retrieved and assembled to create a complete advertisement using media objects selected to have characteristics or to present information appropriate for the user and for their position in the advertisement. For example, as described in greater detail below, media objects may comprise video clips, some of which may be interchanged with others, and which may be assembled in sequence to form a commercial. Other examples may be audio clips, still images, text, and any other desired form of media content.

Each object may suitably include associated information, such as the product or service with which they are associated and the manufacturer or provider of the product or service. Additional information may include the nature of the object, such as a video clip, audio clip, still image, or the like. Further information may include an indicator of the content of the object, such as a scene showing a product in use, a recitation of the benefits of a product, or a summary of legally required information. Still further information may include an object's allowed positions within a sequence. Numerous additional associated information items may be used as desired, with such information being included, for example, in tags associated with an object, with the tags being able to be read and acted on by an appropriate module responsible for selecting and assembling objects.

The server 108 may also host a user information repository 168, comprising a plurality of databases with appropriate entries for each user. The user information database 168 may include a stream information database 170, a user preference and profile database 172, and a behavioral information database 174. The server 108 hosts such a user information repository 168 for all users, and appropriate information may be duplicated for the users of the particular set top box 104 in the user information repository 136. The user information repository 136 may include a household user preference and profile database 176 and a household user behavioral information database 178.

The server 108 also hosts an advertisement database 180 including descriptive information for advertisements to be made available to users. The advertisements will typically be constructed at the time of delivery, and will be constructed so as to conform to user preferences and estimated responsiveness. Actual advertising content may be drawn from numerous different sources, but the advertisement database 180 may suitably include descriptive information, including product, target market, level of detail of advertisements and other relevant descriptive information. Each advertisement may suitably be in the form of a framework, or advertisements may be constructed using rules, and such frameworks or rules may be used for construction of advertisements based on in formation relating to user preferences or behavioral predictions. Rules associated with advertisements may be stored in a rules database 181, and examples of such rules are discussed in greater detail below.

As noted above, as the video stream is presented, it is also monitored and the various aspects of extracted information are transferred to the server 108, where they may be stored in the stream database 170. When an appropriate point for advertisement placement is reached, a placement analysis module 182 is invoked. The placement analysis module 182 uses appropriate user information from the database 168 and makes determinations and predictions relating to user interests and responsiveness to advertisements. The placement analysis module 182 then searches the advertisement database 180 for advertisement descriptions matching the determinations and predictions. The advertisement database 180 may include descriptions comprising frameworks presenting relatively well defined advertisement structures, and may also include more general definitions, for example, designating the product in question and allowing for additional aspects of the advertisement to be chosen at construction time.

The server also hosts an advertisement construction module 184. The advertisement construction module selects appropriate advertisement components based on the description selected from the database 180 and the determination made by the placement analysis module 182. The advertisement construction module 184 may use tags or other appropriate information associated with media objects to make its selections. In the case of an advertisement framework, the framework may designate the duration of the advertisement and the components to be included in the advertisement. The components may be chosen from a variety of different available components, with the components being chosen based on their estimated appeal to the user.

For example, for the same product or service, users may be receptive to advertisements with greater or lesser detail, or may be oriented toward different sets of product features. For example, with respect to the same automobile, some users may be more responsive to advertisements emphasizing the safety features, while others may be more responsive to advertisements emphasizing performance features. Still other users may be responsive to advertisements presenting multiple sets of features.

For financial services, some users may be more responsive to advertisements relating to general themes of stability and expertise, while others may be more responsive to advertisements relating to matters such as historic rates of returns, stability, specific safeguards taken against risk, and other matters. An advertisement framework for an advertisement may suitably include a set of rules for selection and assembly of components for a particular advertisement, and may specify that media objects at different points in the advertisement be drawn from specific categories. For example, an advertisement framework may define an advertisement as comprising an introductory element, various descriptive elements, and a concluding element, with each of these elements being drawn from specified categories. An advertisement framework for an automobile advertisement from a particular manufacturer may specify that the conclusion include legal descriptions relating to finance and lease offers described elsewhere in the advertisement, and may also specify that more generalized information relating to pricing and financing opportunities be presented in the advertisement, and may designate insertion points for components relating to each of these aspects. The introductory element may be specified as being drawn from a set of standard introductory scenes, such as scenes of an automobile on a test track, scenes of an automobile transporting a family at night, scenes of a buyer at a dealer, or other introductory material. The introductory element might be followed by a number of elements describing one or more different features of the automobile or aspects of its use, which could be interchanged between advertisements for the same vehicle, with the advertisement finishing with a concluding element. The framework would include insertion points, with each insertion point suitably including a descriptor or other marker specifying that one of a group of components matching the descriptor would be inserted at that insertion point. Specific choices as to which specific component from each group was to be inserted would be made at the time of construction based on determinations made by the placement analysis module 182.

When an advertisement is to be placed in a media presentation, such as a television program or movie, the placement analysis module 182 may first examine user information to determine which content is appropriate for the user. Such determination may take into account the specific perceived and estimated needs of the user at a particular time, and may be based in part on the nature of the program the user is watching and the user's behavior in switching between programs and channels. For example, the nature of commercials played during programs may be known. The user's behavior in changing away from specific commercials or continuing to allow commercials to play may be noted. In the case of a system providing digital video recording (DVR) features, the user's fast forwarding through commercials or rewinding and replaying commercials or portions of commercials may be noted. In the case of replaying commercials or portions of commercials, the user's actions may be taken to indicate a higher interest in the subject of the commercial.

Additional relevant information may include the user's preferences with respect to advertisements themselves, demographic groups to which the user belongs, and any other information relating to the types of advertisements to which a user is likely to respond. For example, information relating to past user behavior taken from a number of sources may be collected and analyzed and used to create a model relating to user interests and responsiveness to advertisements.

A substantial amount of information relating to user preferences for and interest in products and services may be available. For example, if agreed to by the user, direct observations of the user's behavior as it relates to advertisements such as ordering based on advertisements, reviewing advertisements, or ignoring advertisements, can be used to determine the user's interest in the subject of the advertisements, and different advertisements having different structures may be presented to the user in order to determine the user's responsiveness to the various structures. For example, a commercial might be presented in a longer than typical format, giving comprehensive information relating to the technical details of the product. If a user responds favorably to such an advertisement, such responsiveness can be noted and used to choose longer more comprehensive advertisements for appropriate products. It is also possible to query a user directly as to whether he or she wishes more detail and retrieve and present available components providing such detail. The decision as to whether to present such a query may be made according to any number of criteria, such as a user's positive response to a previous general query as to whether he or she might wish choice to receive additional detail, or a history of observed user behavior, such as a history of positive or negative responses to an opportunity to receive additional detail in connection with different advertisements.

In addition to direct observations of users, various modeling techniques may be used to estimate user responsiveness when particular characteristics and behaviors of a user have not been observed but when related characteristics and behaviors, or behaviors and characteristics of related users, have been observed. One suitable technique that may be used is collaborative filtering operating at multiple scales. Various factors representing generalizations or specific observations about the user behavior are computed or estimated for the user, at varying levels of detail. For example, a broad factor might relate to the global popularity of various items that might be advertised, with all users being estimated to have a higher likelihood of interest in very popular items. A narrower factor might relate to whether the user is an early adopter of new technologies, and a narrower factor based on more specific observations might be based on comparisons between the user's behavior and expressed preferences against the behavior and expressed preference of other users. For example, a user might not have expressed a specific preference about a particular product, but other users showing behavior patterns similar to the user in question might show an interest in the product, so that the interest of those users might be imputed to the user in question. Such techniques are described in Koren, Bell, and Volinsky, “Improved Systems and Techniques for Modeling Relationships at Multiple Scales in Ratings Estimation,” U.S. patent application Ser. No. ______, filed on ______, assigned to the common assignee of the present invention and incorporated herein by reference in its entirety. Related techniques are described in Koren and Bell, “Systems and Techniques for Improved Neighborhood Based Analysis in Rating Estimation,” U.S. patent application Ser. No. ______, filed on ______, assigned to the common assignee of the present invention and incorporated herein by reference in its entirety. If desired, user queries may be presented investigating a user's actual response to advertisements, with responses to such queries being used to refine models for the user behavior. Such queries may be presented during or after the presentation of advertisements, or through other desired mechanisms, such as through user surveys.

Once the placement analysis module 182 has determined appropriate advertisement structure and content for the user, the results of the determination are passed to the advertisement construction module 184. The advertisement construction module 184 consults the advertisement information database 180 to identify descriptions compatible with the determinations made by the placement analysis module 182. The advertisement construction module 184 then assembles an appropriate advertisement. The server 108, and therefore the advertisement construction module 184, has access to one or more collections of media objects that may be used as subcomponents in construction of an advertisement, here illustrated as being stored in the database 167. In addition or as an alternative to storage by the system 100, appropriate elements of the system 100, such as the server 108, may have access to advertiser databases that store media objects created by advertisers. For example, the advertisement construction module 184 may have access to an advertiser server 188. The advertiser server 188 may suitably host a repository 190, with the repository 190 storing media objects created by the advertiser by or for whom the repository 190 is maintained, with the advertiser creating the media objects according to criteria established by the operator of the system 100.

As noted above, each media object, whether stored in the system 100 or elsewhere, may suitably include appropriate associated information, which may come in the form of tags. Tags may include designations of the product and product category to which the subcomponent relates, the length of the subcomponent the level of detail of information provided by the subcomponent, the nature of information provided by the subcomponent, the location in the advertisement of the subcomponent, the context into which the subcomponent fits, and additional relevant information.

For example, a subcomponent may include tags indicating that it is a detailed recitation of handling specifications of a particular make and model of automobile, that it is used in extended length commercials, that it is to be used in one of a set of advertisements including sequences of narrators describing various aspect of automobile components, and that it is to be used in the third, fourth, or fifth position in an advertisement consisting of seven subcomponents. Numerous different organizational structures are possible. For example, subcomponents may be linked together in a sequence, with the order in which they appear in the sequence being based on the descriptors found in the subcomponents that are chosen. In another example, one subcomponent may be thought of as a master subcomponent, presenting an overall frame for the advertisement, including material that is fixed for advertisements using that particular master subcomponent. For example, a master subcomponent may include a standard introduction and ending, and may accommodate linking to one or more interchangeable subcomponents that are presented after the introduction.

To take an example of the operation of the system 100, a user identifies himself to the set top box 100 using the remote control 120, and selects a program relating to the events leading up to the German invasion of Poland in 1939. The user is known to be male, 42 years of age, and living in a household consisting of himself, his wife, 39, and two girls of 14 and 12. Previous activities of the user indicate interest in automobiles, outdoor activities, stamp collecting, and historical tours. Such information has been compiled from information taken from a wide variety of sources, including the user's demographic and preference information provided by the user and stored in the preference and profile database 176, and information taken from monitoring of the user's activities, stored in the user behavior database 178. Behavioral information can be taken from a wide variety of sources. In the present exemplary case, for example, the user's online activities include frequent participation in discussion forms related to automobiles and stamp collecting, and frequent research on outdoor activities in his area. The user has taken 3 historical tours in the past 5 years, investigating and booking the tours online. In addition, the user's television viewing activities indicate an interest in television programs relating to twentieth century history, police dramas, and garden and home design. The user tends to buffer his or her television viewing and to fast forward through commercials, but tends to watch commercials relating to particular product categories, although these product categories may change from time to time. For example, during various periods, the user has watched commercials for cruise vacations, for automobiles, and for home repair services, and it may be judged that the user tends to watch commercials for products for which he has a relatively immediate need, because the user has made purchases in each of these categories shortly after the periods in which his viewing habits included the viewing of related commercials without fast forwarding. In the current period, the user tends to watch commercials for gardening and home design and repair, and to reverse and rewatch commercials that have significant technical detail.

As noted above, in the particular interval under examination, the user is watching a program on the invasion of Poland in 1939. The content of this program is received by the set top box from the content distribution center 118 over the network 109, and delivered to the user television 106. The user's viewing of the program is monitored, and pauses, channel changes, and viewing of commercials are noted. The program has scheduled commercial breaks that are to be populated with appropriate content by the set top box 104.

During the first commercial break, time is available for 2 minutes of commercials. The placement analysis module 182 determines that a commercial for an XE-1 off-road motorcycle is appropriate, and directs the advertisement construction module 184 to construct an appropriate advertisement. The advertisement construction module retrieves an appropriate advertisement framework from the advertisement database 180. The framework retrieved includes a designation of the product, with spaces for first through fourth elements. The first and fourth elements are to be standard introductory and concluding elements, respectively. The advertisement construction module 184 selects the first through fourth media objects from the content repository 167. The media objects selected for the third and fourth elements may be chosen from a variety of different objects designated as acceptable for the segment position. In the present example, the third element is a scene showing the motorcycle in use in a location relatively near the user's residence, and the fourth element provides a recitation of technical details of the motorcycle. Once the elements have all been retrieved, they are placed as indicated by the framework and the advertisement so constructed is delivered to the set top box 104. The advertisement may, for example, be inserted into storage 130 in the DVR system, where it may become part of the programming stream, controllable by the user.

The user allows the commercial to play without fast forwarding, and reverses and rewatches the element providing technical details. This activity is noted and stored in the behavioral information database 174, and is immediately available to inform selection and presentation of subsequent commercials in the block, and may also be used at any later time.

The next commercial is for a historical tour from the company Battletours, Ltd. In this case, the advertisement construction module 184 assembles a commercial introducing the company, giving an overview of its services and costs, and a survey of the areas that may be visited. The advertisement construction module 184 constructs this advertisement according to rules that take into account the estimated interests of the user, and rules specified for construction of advertisements for the company. The rules specify that the first, or the first few, presentations of advertisements concerning the company will be in the form of a general overview, assembled from specified components fitting into a specific sequence. The rules further specify that once a user is deemed sufficiently acquainted with the company to be familiar with the company's services in general, the construction of advertisements tends more toward discussion of available specific tours, either more or less randomly chosen, or chosen to coincide with a user's estimated interests, if sufficient information has been gathered to estimate those interests. The advertisement construction module 184 selects segments presenting an introduction to the company, a collage of battle scenes, a collage of scenes of the same battles as they appear at present, and a close with contact information for the company. The user rewinds this advertisement to the beginning and plays it a second time, and rewinds again and rewatches the segment presenting contact information. This information is stored in the database 174.

The program resumes, and continues to another commercial block. Because the user showed so much interest in the Battletours commercial, the placement analysis module 182 selects another Battletours commercial for presentation, which is constructed according to a set of rules, which may be the same set of rules discussed above. Because the user showed considerable interest in the previous presentation of the advertisement, a more specific advertisement is assembled, based on regions in which the user has shown an interest in the past. The advertisement construction module 184 retrieves an initial segment presenting an introduction. Additional segments are retrieved presenting the itinerary of an upcoming tour of historical battle sites of World War I. Because the user has shown an interest in historical lectures, the segments include one segment presenting a collage of images and descriptions of sites to be visited, followed by a segment presenting an overview of lectures to be presented by experts accompanying the tour. Only general descriptions of accommodations and meals are presented. If the user's interests had been determined to include more emphasis on the quality of meals and accommodations and less on historical lectures, the rules provide for selecting segments accommodating such interests. Once the segments have been assembled, the advertisement is delivered to the set top box 104 for presentation.

One category of subcomponents that may advantageously be used comprises three dimensional objects that are wholly constructed in software and may be interchanged with one another. For example, a scene may be created comprising an automobile driving along a highway, with elements of the scene comprising various three dimensional objects, and various components of the scene. Different components could be used in the scene, depending on the specific determinations made by the placement analysis module 182. For example, a different model of automobile might be used in versions of the advertisement presented to different users, or different properties might be used for an automobile in the scene. For example, the automobile might be given a higher or lower initial velocity for its entry into the scene depending on whether performance features are to be emphasized. Alternatively or in addition in order to emphasize handling characteristics related to safety, an oncoming vehicle could be added to the scene and the subject vehicle braked and swerved to avoid a collision. Various static elements of the scene could be interchanged, such as buildings, and additional elements could be interchanged, such as drivers and passengers in the automobile, or passersby. Humans in the scene could be interchanged to match characteristics of the user, for example, placing a driver and passengers in the automobile that were similar to the user's family.

Advertisement construction may be described by an advertisement construction language designed to designate the various components of an advertisement ad the various points to be emphasized by the advertisement. The choices of components and combinations of components with one another may be controlled by a set of rules stored in the rules database 181. Rules may control which subcomponents may be used together, where in an advertisement a subcomponent may be used, and may enforce other considerations directed toward constructing advertisements that are appropriate and coherent. For example, rules may insure that sequential subcomponents portraying an automobile driving on a highway present the same automobile driving along the same highway. Descriptors can be used to indicate the conditions referred to by the rules, and if desired and if sufficient processing resources exist, the descriptors can be generated through automatic analysis of the subcomponents.

An additional feature of a system such as the system 100 includes the ability to substitute different elements in a scene that is being presented as part of programming. Many entertainment presentations employ product placement, in which a vendor pays a programming provider to use the vendor's product in the content of the programming. Especially as the generation of programming content becomes more and more sophisticated, the capabilities of substituting various programming elements continue to increase, leading to increased capability to provide appropriate product placement in programming. As noted above, as programming is presented to a user, the placement analysis module 182 monitors the stream 156 that is being shown and also monitors the user information to determine which advertising content is appropriate for presentation to the user. In addition to directing the placement of commercials between programming presentations, the placement analysis module 182 may also direct the placement of elements within programming presentations. Particularly in cases in which programming comprises collections of objects, substitution of objects can be accomplished without noticeable alteration to the content being presented. Therefore, the advertisement database 180 may also include information relating to the identification and use of objects to be substituted within programming and the repository 190 may include objects that can be substituted within the programming. Objects stored in the repository 190 for use in product placement may include descriptors indicating the identity and nature of the product, and may include size, orientation, and motion attributes. When an object is substituted in a scene, the size, orientation, and motion attributes of the object originally in the scene may be applied to the substituted object, causing the substituted object to appear in a similar way to the original object.

Once an advertisement has been constructed, the complete advertisement, or aspects of the advertisement, may be retained for later use. Various aspects of certain advertisements may be particularly appealing to a user. For example, a user having a high interest in technology may find himself or herself receptive to longer, more descriptive advertisements relating to technology products, and the user's responsiveness to such advertisements may be noted. The construction of such advertisements may be retained and used for future advertisements directed to that user. In addition, a user may choose to save a particular advertisement structure, which may then be used for future advertisements. When a saved structure is used, the advertisement construction module 184 retrieves subcomponents appropriate to the saved structure and populated the saved structure with appropriate components. The resulting advertisement is then presented to the user.

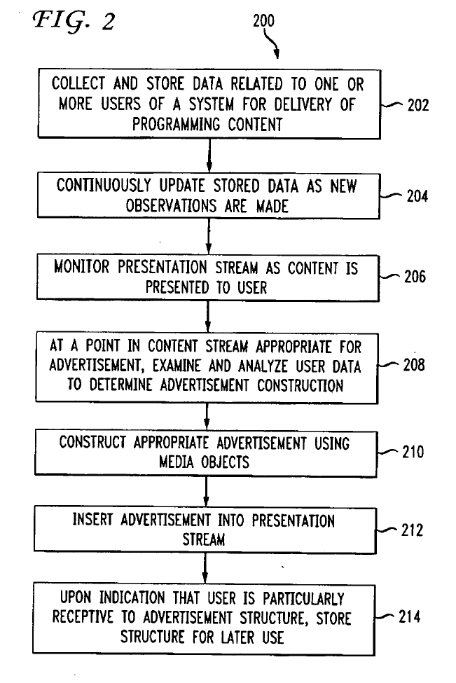

FIG. 2 illustrates a process 200 of advertisement creation and presentation according to an aspect of the present invention. The process 200 may suitably be performed using a system similar to the system 100 of FIG. 1. At step 202, data related to one or more users of a system for delivering programming content is collected and stored. Data collection may be performed, for example, for users within a household. The data may include data related to demographic characteristics of the user or users, expressed user preferences, data relating to interaction with the system, such as billing and payment, membership in organizations, such as technology user groups, product or activity interest groups, and other collected data. Further data may include data relating to user behavior, such as behavior relating to the system, such as selection of programming and viewing of advertisements presented using the system. Further data relating to user behavior may include any such data authorized by the user to be collected, such as broadband use, ordering behavior, and other behavior indicating responsiveness to advertisements.

At step 204, the stored data is continuously updated as new data is made available. At step 206, as content is presented to a user, the content stream is monitored. At step 208, when a point in the content stream appropriate for an advertisement is reached, the stored data is examined to estimate user receptiveness to advertisements and to determine construction of appropriate advertising material to which a user will be receptive. The evaluation may be made based on observations of user data and behavior and by modeling techniques used to estimate user characteristics based on related user behavior and behavior of other users related to the user under consideration. At step 210, an advertisement is constructed that is appropriate for placement in the content stream based on evaluation of user receptiveness. Construction may suitably be performed by selecting, modifying, and combining one or more media objects, according to structure and rules for selection and use of media objects.

For example, media objects may comprise interchangeable scenes and an advertisement may be constructed selecting and combining scenes appropriate for a particular advertisement, with the scenes selected and ordered so as to emphasize aspects of the product or service being advertised in a way appropriate to a user. An advertisement structure may be selected or created for presenting scenes for a particular product or category of products, and the structure may be populated with scenes selected and ordered in a way appropriate for the user.

To take another example, if an advertisement is to be in the form of product placement in programming content, an object appropriate for the product or service being advertised may be selected, and attributes for the object may be selected so as to adapt the selected object to fit in the scene in the place of the object being replaced. For example, an automobile being advertised may replace an automobile appearing in a scene, with a video object representing advertised automobile being given size, orientation, and velocity attributes similar to those of the automobile being replaced.

At step 212, the constructed advertisement is inserted into the presentation stream. At step 214, when a user indicates a particular interest in an advertisement that has been or is being presented, or when user behavior indicates receptiveness to the advertisement, the structure of the advertisement is stored in association with the user for later retrieval for use in advertisements to be directed to the user.

While the present invention is disclosed in the context of a presently preferred embodiment, it will be recognized that a wide variety of implementations may be employed by persons of ordinary skill in the art consistent with the above discussion and the claims which follow below.

We claim:

1. A server for constructing customized content for delivery to a user, comprising:
a data interface for delivering a data stream comprising content to be delivered to the user;
a repository of user information relating to the user;
a processor for selecting and managing content and organizing the data stream, the processor being operative to examine and process user information to determine user receptivity to customized content items, the processor being further operative to examine media objects to which the server has access, the processor being operative to select appropriate media objects and construct a customized content item incorporating the media objects and to place the customized content item Into the data stream.

2. The server of claim 1, wherein the data interface delivers the data stream to a user device preparing and delivering a content stream to the user based at least in part on the data stream delivered from the data interface, wherein the data interface is operative to receive information from a user device indicating the content stream being presented to the user and wherein the processor is operative to perform analysis of user information and construction of an customized content item when a point is reached in the content stream being presented to the user that is appropriate for the customized content item.

3. The server of claim 1, wherein the processor is operative to construct a customized content item by selecting and organizing a plurality of appropriate media objects.

4. The server of claim 3, wherein the processor constructs a customized content item by selecting a framework and populating the framework with a plurality of appropriate media objects.

5. The server of claim 3, wherein the processor is operative to select and organize media objects according to stored rules.

6. The server of claim 3, wherein one or more of the media objects are drawn from a plurality of mutually interchangeable media objects.

7. The server of claim 1, wherein the user information includes information relating to user behavior and wherein the user information is continually updated as new observations of user behavior are made.

8. The server of claim 3, where the customized content item is an advertisement.

9. The server of claim 2, wherein analysis of user information includes determining the length and detail of advertisements that appeal to the user and wherein advertisement construction includes selecting and organizing media objects so as to provide a suitable level of detail.

10. The server of claim 1, wherein the data stream comprises data to be presented to the user as an audio video stream representing entertainment programming.

11. The server of claim 3, wherein the customized content item is an advertisement and wherein constructing an advertisement includes selecting one or more media objects representing advertised products and using the selected media objects to replace corresponding objects present in a scene presented as an entertainment offering.

12. The server of claim 11, wherein constructing an advertisement includes setting attributes for a selected media object to match corresponding attributes for the object being replaced.

13. A method of delivering programming to a user, comprising the steps of;
collecting and storing user information relating to a user;
delivering programming content to the user as an audio video stream;
during delivery of the programming content, examining and analyzing the user information to determine user receptivity to customized content;
selecting and organizing available media objects to construct customized content based on the examination and analysis of the user information; and
placing the customized content into the audio video stream.

14. The method of claim 3, wherein the step of delivering programming content to the user as an audio video stream includes continuously monitoring the content selected by the user for delivery and wherein examining and analyzing the user information takes place whenever a point is reached in the audio video stream for placement of customized content.

15. The method of claim 14, wherein the step of constructing customized content comprises selecting a framework and populating the framework with a plurality of appropriate media objects.

16. The method of claim 15, wherein one or more of the media objects are drawn from a plurality of mutually interchangeable media objects.

17. The method of claim 13, wherein the customized content comprises advertisements.

18. The method of claim 17, wherein the step of delivering programming content to the user as an audio video stream includes continuously monitoring the content selected by the user for delivery, and wherein the method further comprises a step of continuously evaluating the content stream to determine whether a product placement advertisement is appropriate based on examination of the user information.

19. The method of claim 18, wherein the step of selecting and organizing media objects to construct advertising content includes selecting an object representing a product determined to be of interest to a user and using the selected object to replace an object present in a scene presented as part of entertainment programming.

20. The method of claim 19, wherein constructing an advertisement includes setting attributes for a selected media object to match corresponding attributes for the object being replaced.
